(19) United States
(12) Patent Application Publication
(10) Pub. No.: US 2003/0034617 A1
(43) Pub. Date: Feb. 20, 2003

(54) Wafer chuck with plunger

(75) Inventors: Bernardo Donoso, San Jose, CA (US); Yeuk-Fai Edwin Mok, San Francisco, CA (US)

Correspondence Address: PATENT COUNSEL, APPLIED MATERIALS, INC., Legal Affairs Department, P.O. Box 450A, Santa Clara, CA, 95052, US

(73) Assignee: APPLIED MATERIALS, INC.

(21) Appl. No.: 10/218,170

(22) Filed: Aug. 13, 2002

Related U.S. Application Data
(60) Provisional application No. 60/312,336, filed on Aug. 14, 2001.

(51) Int. Cl. B32B 31/00

(52) U.S. Cl. 279/3

(57) ABSTRACT

A wafer chuck is provided, having a wafer chucking surface, and a plunger consisting either of a body that extends at least partially along the outer perimeter of the wafer chucking surface, or a plurality of pins positioned outside the wafer chucking surface. The plunger may be normally biased to extend past the wafer chucking surface and/or may be adapted not to rotate with the wafer chucking surface. The plunger bias may be achieved via one or more vacuum bellows.

This application claims priority from U.S. Provisional Patent Application Serial No. 60/312,336, filed Aug. 14, 2001, which is hereby incorporated by reference herein in its entirety.

### FIELD OF THE INVENTION

The present invention relates to a method and apparatus for chucking a wafer. More specifically, the invention relates to a method and apparatus for dechucking a wafer from a wafer chuck.

### BACKGROUND

A number of semiconductor fabrication processes hold a semiconductor wafer in place via an apparatus conventionally referred to as a wafer chuck. A wafer chuck attracts a wafer to a flat surface known as a wafer chucking surface, thus allowing the wafer to be held in place without using clamps which would by necessity cover a portion of the wafer's edge. Wafer chucks provide access to a wafer's entire circumference.

Typically, to attract the wafer the wafer chucking surface may selectively generate either an electrostatic charge or vacuum suction so as to selectively hold or release the wafer, as is known in the art. In order to properly attract and hold the wafer, the wafer chucking surface must make even contact across the flat surface of the wafer. Thereafter when wafer processing is complete, the attractive force (e.g., electrostatic charge or vacuum suction) is removed. Often, however, the wafer does not smoothly and evenly disengage from the wafer chucking surface. Accordingly some wafer chucking surfaces include pins which extend from the wafer chucking surface to aid wafer de-chucking after the wafer chucking surface's attractive force is removed. It has been known to use pressurized air to cause such pins to extend from the wafer chucking surface. This requires a mechanism for evenly supplying air pressure to each of the pins, in order to ensure smooth and even wafer de-chucking. In addition to increasing the cost and complexity of the wafer chuck, such systems reduce the chuck's attractive surface area.

### SUMMARY OF THE INVENTION

A wafer chuck is provided, having a wafer chucking surface, and a plunger consisting of either a body that extends at least partially along the outer perimeter of the wafer chucking surface, or a plurality of pins positioned outside the wafer chucking surface. The plunger may be normally biased to extend past the wafer chucking surface and/or may be adapted not to rotate with the wafer chucking surface. The plunger bias may be achieved via one or more vacuum bellows.

### BRIEF DESCRIPTION OF THE DRAWINGS

FIG. 1 of an isometric bottom view of a wafer chuck assembly;

FIG. 2 is an isometric side cross-sectional view of the wafer chuck assembly of FIG. 1;

FIG. 3 is a side schematic view of a processing chamber having the inventive wafer chuck mounted opposite a wafer exchange location; and

FIG. 4 is a top plan view of an alternative embodiment of the inventive wafer chuck assembly.

### DETAILED DESCRIPTION OF THE DRAWINGS

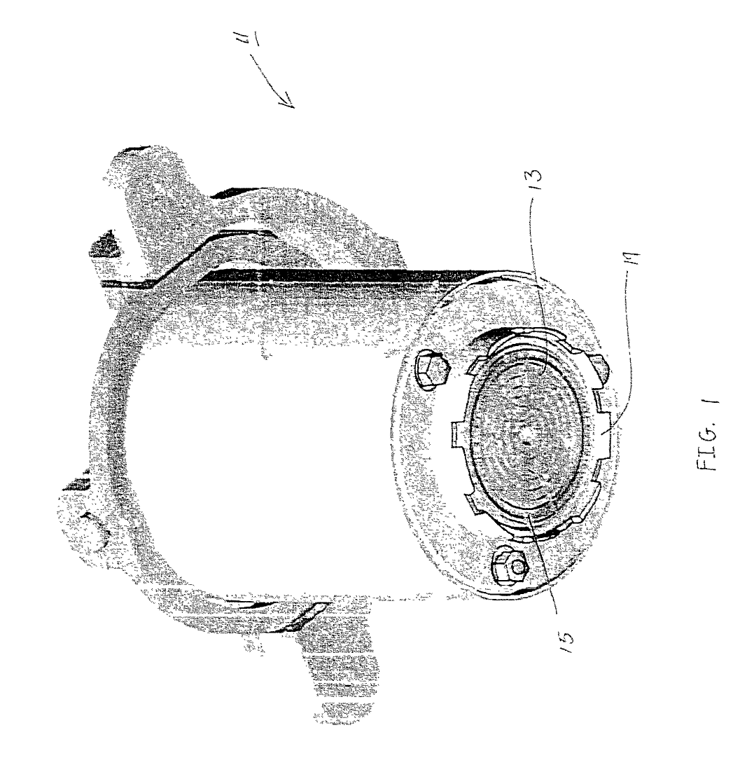

FIG. 1 of an isometric bottom view of a wafer chuck assembly 11 comprising a wafer chucking surface 13 adapted to selectively apply a vacuum or an electrostatic charge so as to attract a wafer thereto. The wafer chucking surface 13 may comprise a sealing member 15 made of a resilient material such that the sealing member may form a seal when pressed against a wafer surface. Surrounding the wafer chucking surface 13, is a plunger 19 adapted to extend and retract with respect to the wafer chucking surface 13. The wafer chucking surface 13 may have a smaller footprint (e.g., circumference) than that of a wafer to be chucked. The plunger 19 is positioned within the footprint of a wafer chucked to the wafer chucking surface 13, such that when the plunger 19 extends past the wafer chucking surface 13, a wafer coupled to the wafer chucking surface 13 is de-chucked thereby.

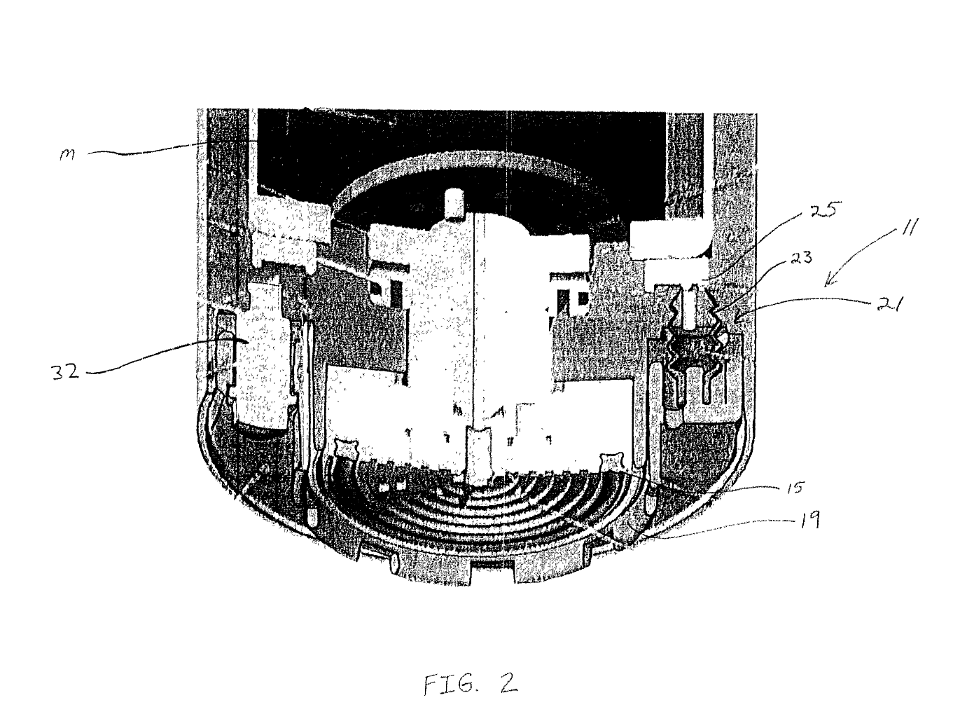

FIG. 2 is an isometric side cross-sectional view of the wafer chuck assembly 11 of FIG. 1, which shows in detail the mechanisms which control the operation of plunger 19. As shown in the embodiments of FIGS. 1 and 2, the plunger 19 comprises a circular member which surrounds the entire circumference of the wafer chucking surface 13. The plunger 19 is movably mounted within a processing chamber (not shown) via a plurality of actuators 21 which include a biasing mechanism for normally biasing the plunger 19 to its extended position, such that the plunger 19, absent outside actuation, normally extends beyond the wafer chucking surface 19. The plurality of actuators 21 also comprise a vacuum source adapted to selectively retract the plunger 19. In the embodiment shown, each of the actuators 21 comprises a vacuum bellows 23 which normally biases the plunger 19 to its extend position, and a vacuum source 25 which is sealingly coupled to the vacuum bellows 23 so as to selectively generate a vacuum therein, causing the vacuum bellows to retract thereby pulling the plunger 19 to its retracted position.

Because the vacuum bellows 23 is employed both for biasing the plunger 19 to its extended position, and for applying vacuum, the inventive de-chucking mechanism of the wafer chuck 11 may require fewer parts than conventionally required to de-chuck a wafer. Because the plunger 19 preferably extends around the entire circumference of the wafer chucking surface 13, the force the plunger 19 applies to the wafer may be more evenly distributed than that of prior art wafer de-chucking mechanisms. Moreover, because the plunger 19 preferably extends around the entire circumference of the wafer chucking surface 13, it may effectively average the actuating force applied by any individual actuator 21. Accordingly if one of the actuators 21 operates erroneously faster than another one of the actuators 21, the effect of the erroneous actuation is averaged by the circumferential design of the plunger actuated thereby. Also, because the de-chucking mechanism does not extend from the wafer chucking surface 13, it may be more simply designed, as it does not need to rotate with the wafer chucking surface 13. A motor M may be employed to rotate the wafer chucking surface 13; and a mounting mechanism 32 may be provided for mounting the inventive wafer chuck 11 (e.g., such that the plunger 19 lifts and lowers relative to the mounting mechanism 32 without rotating with the wafer chucking surface 13).

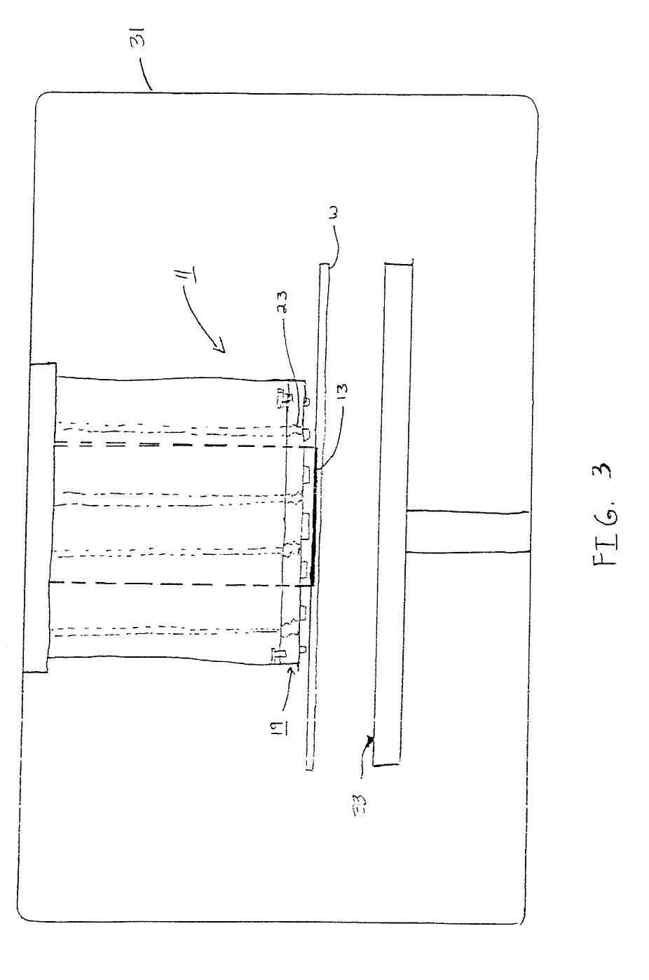

FIG. 3 is a side schematic view of a processing chamber 31 having the inventive wafer chuck 11 mounted opposite the wafer exchange location 33. In operation a wafer (W) is placed on the wafer exchange location 33, a vacuum is generated within the bellows 23, causing the bellows 23 and plunger 19 to retract, and the wafer chuck 11 is lowered so as to contact the wafer positioned on the wafer exchange location 33. An attractive force is generated across the wafer chucking surface 13 (e.g. electrostatic charge or vacuum suction), and the wafer chucking surface 13 is pressed against the wafer positioned on the wafer exchange location 33. In a vacuum embodiment such as that shown, the sealing member 15 forms a seal against the wafer thereby aiding suction between the wafer and the wafer chucking surface 13.

The wafer chuck 11 is then elevated and wafer processing may begin. For example the wafer may be spun while an etchant is applied to a beveled edge thereof. After processing is complete the wafer chuck 11 lowers, placing the processed wafer on the wafer exchange location 33. Thereafter the vacuum suction applied to both the wafer chucking surface 13 and to the bellows 23 ceases.

When the vacuum suction is removed from the bellows, the bellows return to their normal extended position, pushing the plunger 19 past the wafer chucking surface 13 to its extended position. As the plunger 19 moves past the wafer chucking surface 13 to its extended position it may gently and evenly press against the wafer causing the wafer to disengage from the sealing member 15.

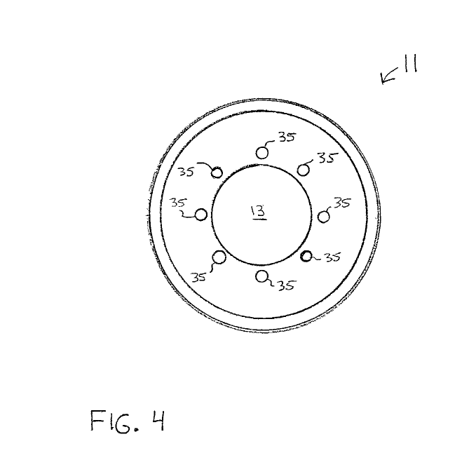

The embodiment disclosed is merely exemplary. Rather than employing a circumferential plunger, an alternative embodiment, as shown in the top plan view of FIG. 4, may employ a plurality of pins 35 positioned outside the wafer chucking surface 13 (which are normally biased to an extended position, and which are retracted via vacuum suction). Although a plunger that extends around the outer perimeter (i.e., outside the footprint) of the wafer chucking surface is preferred, the plunger may comprise one or more parts that extend at least partially along the wafer chucking surface's outer perimeter. Preferably any plunger comprised of a plurality of parts (e.g., pin, sections that extend along a portion of the wafer chucking surface's perimeter, etc.) will have the plunger parts positioned at spaced intervals around the perimeter of the wafer chucking surface.

Naturally, although the wafer chucking surface is preferably mounted such that the plunger 19 extends downwardly therefrom, the wafer chucking surface may be mounted in other positions as well (e.g., along a bottom or a sidewall of a chamber).

In addition to the above, the design as shown in the figures is such that all components of the plunger mechanism (plunger, plunger holders, and actuation bellows) can be made of materials such as PP (Polypropylene), PVDF (PolyVinylidene Fluoride), PFA (PerFluoroAlkoxy), Viton (Fluoroelastomer™ by DuPont Dow Corp.), Kalrez (Perfluoroelastomer™ by DuPont Dow Corp.), etc., which are highly resistant to wet corrosive environments found in semiconductor processing (e.g., dilute sulfuric acid, etc.). Therefore they are less likely to contaminate the processing and other metallic components.

Accordingly, while the present invention has been disclosed in connection with exemplary embodiments thereof, it should be understood that other embodiments may fall within the spirit and scope of the invention, as defined by the following claims.

The invention claimed is:

1. A wafer chuck comprising:
a wafer chucking surface adapted to selectively attract a wafer; and
a plunger extending at least partially along the outer perimeter of the wafer chucking surface and adapted to selectively extend and retract with respect thereto.

2. The apparatus of claim 1 further comprising a biasing mechanism coupled to the plunger so as to normally bias the plunger to its extended position.

3. The apparatus of claim 1 wherein each of the plurality of biasing mechanisms comprises a vacuum bellows.

4. The apparatus of claim 2 wherein the biasing mechanism comprises a vacuum bellows.

5. The apparatus of claim 4 wherein the plunger and biasing mechanism are adapted to resist corrosion in a wet processing environment.

6. The apparatus of claim 1 wherein the wafer chucking surface is adapted for vacuum chucking a wafer.

7. The apparatus of claim 6 wherein the wafer chucking surface includes a resilient member for forming a vacuum seal against a wafer.

8. The apparatus of claim 1 wherein the plunger surrounds the perimeter of the wafer chucking surface.

9. The apparatus of claim 8 further comprising a plurality of biasing mechanisms coupled to the plunger at spaced intervals and adapted to normally bias the plunger to its extended position.

10. The apparatus of claim 9 wherein each of the plurality of biasing mechanisms comprises a vacuum bellows.

11. The apparatus of claim 8 wherein the wafer chuck is adapted to rotate, and the plunger is not adapted to rotate.

12. The apparatus of claim 11 further comprising a plurality of biasing mechanisms coupled to the plunger at spaced intervals and adapted to normally bias the plunger to its extended position.

13. The apparatus of claim 11 wherein each of the plurality of biasing mechanisms comprises a vacuum bellows.

14. The apparatus of claim 8 wherein the wafer chucking surface is adapted for vacuum chucking a wafer.

15. The apparatus of claim 14 wherein the wafer chucking surface includes a resilient member for forming a vacuum seal against a wafer.

16. A wafer chuck comprising:
a wafer chucking surface adapted to selectively attract a wafer;
a plunger comprising a plurality of pins adapted to selectively extend so as to pass the wafer chucking surface and retract so as not to pass the wafer chucking surface, the plurality of pins being outside the footprint of the wafer chucking surface; and
a biasing mechanism coupled to each of the plurality of pins so as to normally bias each of the plurality of pins to extend so as to pass the wafer chucking surface.

17. The apparatus of claim 16 wherein the wafer chucking surface is adapted to rotate, and the plurality of pins are not adapted to rotate with the wafer chucking surface.

18. The apparatus of claim 16 wherein each of the plurality of biasing mechanisms comprises a vacuum bellows.

19. The apparatus of claim 18 wherein the wafer chucking surface is adapted to rotate, and the plurality of pins are not adapted to rotate with the wafer chucking surface.

20. A method of chucking and dechucking a wafer, comprising:
actively retracting a wafer plunqer that is positioned outside the footprint of a wafer chucking surface;
contacting a wafer with the wafer chucking surface,
applying an attractive force to the wafer and thereby chucking the wafer on the wafer chucking surface;
rotating the wafer chucking surface;
performing a process on the wafer chucked on the rotating wafer chucking surface;
ceasing rotation of the wafer chucking surface;
removing the applied attractive force;
ceasing active retraction of the wafer plunger to thereby cause the wafer plunger to thereby cause the wafer plunger to extend past the wafer chucking surface; and
contacting the wafer with the wafer plunger as the wafer plunger extends past the wafer chucking surface, to thereby facilitate wafer dechucking.

21. The method of claim 20 wherein actively retracting the wafer plunger comprises applying a vacuum force to the wafer plunger to thereby retract the wafer plunger.

22. The method of claim 21 wherein causing the wafer plunger to extend past the wafer chucking surface comprises allowing vacuum bellows to bias the wafer plunger to an extended position.

23. The method of claim 20 wherein rotating the wafer chucking surface does not include rotating the wafer plunger.

24. The method of claim 20 wherein applying an attractive force comprises applying a vacuum force.

25. The method of claim 20 wherein performing a process on the wafer comprises performing an edge cleaning process on the wafer.

26. The method of claim 20 wherein chucking the wafer comprises sealing a resilient member to the surface of the wafer.
